(19) United States
(12) Patent Application Publication
(10) Pub. No.: US 2019/0286745 A1
(43) Pub. Date: Sep. 19, 2019

(54) COMMUNITY-BASED RECOMMENDATIONS

(71) Applicant: Google Inc., Mountain View, CA (US)

(72) Inventors: Dinkar Jain, Menlo Park, CA (US); Arnav Sharma, Menlo Park, CA (US)

(21) Appl. No.: 14/305,220

(22) Filed: Jun. 16, 2014

(51) Int. Cl. G06F 17/30

(52) U.S. Cl. CPC G06F 17/30864

(57) ABSTRACT

Methods, systems, and apparatus include computer programs encoded on a computer-readable storage medium, including a method for providing content. A request is received for a content item for publication in a slot on a publisher site. A content item responsive to the request is identified. The publisher site is identified based on the request. A determination is made when to augment the content item with a feedback item. The content item is augmented to include the feedback item for obtaining feedback from a viewer of the content item. The feedback item includes a query as to a desire of the viewer to share the content item with other members of a community associated with the publisher site. The augmented content item is provided responsive to the request. Feedback is received from the viewer based on interaction with the feedback item once presented. The feedback is associated with the content item.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results. Content in these examples can be of various formats, while the devices that consume (e.g., present) the content can be equally varied in terms of their type and capabilities.

Content slots can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or a likelihood that the user will interact with the content presented.

### SUMMARY

In general, one innovative aspect of the subject matter described in this specification can be implemented in methods that include a computer-implemented method for providing content. The method includes receiving a request for a content item for publication in a slot on a publisher site. The method further includes identifying, using one or more processors, a content item responsive to the request. The method further includes identifying the publisher site based on the request. The method further includes determining based on identifying the publisher site when to augment the content item with a feedback item and when so augmenting the content item to include the feedback item for obtaining feedback from a viewer of the content item wherein the feedback item includes a query as to a desire of the viewer to share the content item with other members of a community associated with the publisher site. The method further includes providing the augmented content item responsive to the request. The method further includes receiving feedback from the viewer based on interaction with the feedback item once presented. The method further includes associating the feedback with the content item.

These and other implementations can each optionally include one or more of the following features. Determining when to augment the content item can include determining when one or more of a sponsor associated with the content item or a publisher associated with the publisher site has approved augmentation. Augmenting can include associating the feedback item with the content item and delivering the content item and the feedback item responsive to the request. Augmenting can include appending to or overlaying the feedback item on the content item creating a single unit and providing the single unit responsive to the request. The method can further include accumulating feedback for the content item from plural different viewers that visit the publisher site, determining statistical relevance of the feedback, and when relevant, using the feedback when deciding content items for delivery to other viewers that visit the publisher site in the future. The method can further include providing a recommendation along with a content item that is delivered based on the accumulated feedback. The recommendation can include an indication of a number of prior viewers of the community that recommended the content item. Associating the feedback with the content item can include storing the feedback, and the method can further include receiving a second request for content for publication in a slot on the publisher page, identifying one or more candidate content items responsive to the request, identifying feedback for the candidate content items based on the storing and using the feedback to select a content item responsive to the second request. The method can further include determining, for a given candidate content item, a statistical relevance of the feedback, and when relevant, using the feedback as a signal in a selection algorithm for determining the content item from the candidate content items. Statistical relevance can be based on interaction rates with content items that are selected when feedback is used to select a given content item.

In general, another innovative aspect of the subject matter described in this specification can be implemented in computer program products that include a computer program product tangibly embodied in a computer-readable storage device and comprising instructions. The instructions, when executed by one or more processors, cause the processor to: receive a request for a content item for publication in a slot on a publisher site; identify a content item responsive to the request; identify the publisher site based on the request; determine based on identifying the publisher site when to augment the content item with a feedback item, and when so, augment the content item to include the feedback item for obtaining feedback from a viewer of the content item, wherein the feedback item includes a query as to a desire of the viewer to share the content item with other members of a community associated with the publisher site; provide the augmented content item responsive to the request; receive feedback from the viewer based on interaction with the feedback item once presented; and associate the feedback with the content item.

These and other implementations can each optionally include one or more of the following features. Determining when to augment the content item can include determining when one or more of a sponsor associated with the content item or a publisher associated with the publisher site has approved augmentation. Augmenting can include associating the feedback item with the content item and delivering the content item and the feedback item responsive to the request. Augmenting can include appending to or overlaying the feedback item on the content item creating a single unit and providing the single unit responsive to the request. The instructions can further include instructions to accumulate feedback for the content item from plural different viewers that visit the publisher site, determining statistical relevance of the feedback, and when relevant, using the feedback when deciding content items for delivery to other viewers that visit the publisher site in the future.

In general, another innovative aspect of the subject matter described in this specification can be implemented in systems, including a system comprising one or more processors and one or more memory elements including instructions. The instructions, when executed, cause the one or more processors to: receive a request for a content item for publication in a slot on a publisher site; identify a content item responsive to the request; identify the publisher site based on the request; determine based on identifying the publisher site when to augment the content item with a feedback item, and when so, augment the content item to include the feedback item for obtaining feedback from a viewer of the content item, wherein the feedback item includes a query as to a desire of the viewer to share the content item with other members of a community associated with the publisher site; provide the augmented content item responsive to the request; receive feedback from the viewer based on interaction with the feedback item once presented; and associate the feedback with the content item.

These and other implementations can each optionally include one or more of the following features. Determining when to augment the content item can include determining when one or more of a sponsor associated with the content item or a publisher associated with the publisher site has approved augmentation. Augmenting can include associating the feedback item with the content item and delivering the content item and the feedback item responsive to the request. Augmenting can include appending to or overlaying the feedback item on the content item creating a single unit and providing the single unit responsive to the request. The instructions can further include instructions to accumulate feedback for the content item from plural different viewers that visit the publisher site, determining statistical relevance of the feedback, and when relevant, using the feedback when deciding content items for delivery to other viewers that visit the publisher site in the future.

Particular implementations may realize none, one or more of the following advantages. Users who receive and view content items (e.g., advertisements) displayed on publisher sites, for example, can see content items that are accompanied by a notification describing how many other users/visitors of that particular publisher, website or community have recommended, approved or engaged with the content item. User feedback and recommendations can be used to optimize algorithms for selecting content and providing more meaningful content to users.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing content.

FIG. 2 shows an example system for receiving user community feedback from a user for association with a content item for subsequent presentation.

FIG. 3 is a flowchart of an example process for receiving user community feedback from a user for association with a content item for subsequent presentation.

FIG. 4 is a block diagram of an example computer system that can be used to implement the methods, systems and processes described in this disclosure.

Like reference numbers and designations in the various drawings indicate like elements.

### DETAILED DESCRIPTION

Systems, methods, and computer program products are described for collecting and surfacing community-based recommendations. For example, collecting the recommendations can be by querying users for feedback when a content item is presented on a publisher site. Surfacing the recommendations, for example, can occur when content items (e.g., the same content item) are presented to other users, such as on the same publisher site. In some implementations, recommendations that are provided by users can be stored and used for selecting content, e.g., in response to a request for content, by selecting content items having positive recommendations over content items having negative recommendations (or no recommendations at all).

For situations in which the systems discussed here collect and/or use personal information about users, the users may be provided with an opportunity to enable/disable or control programs or features that may collect and/or use personal information (e.g., information about a user's social network, social actions or activities, a user's preferences or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

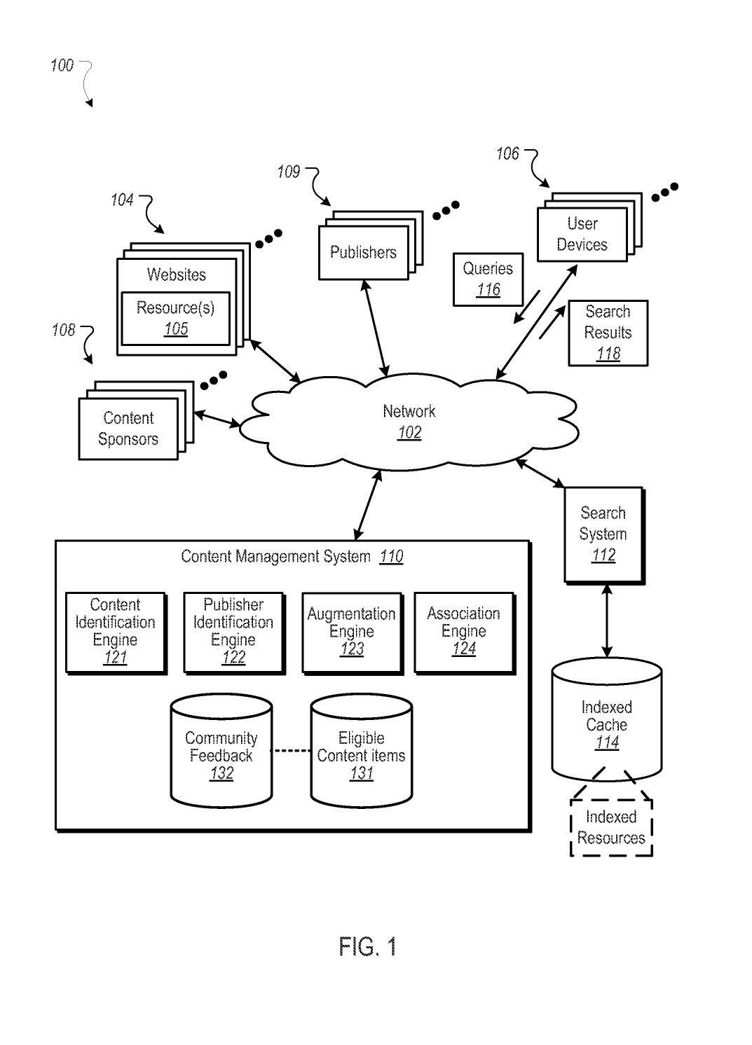

FIG. 1 is a block diagram of an example environment 100 for providing content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content sponsors 108 (e.g., advertisers), publishers 109, and the content management system 110. The example environment 100 may include many thousands of websites 104, user devices 106, content sponsors 108 and publishers 109.

The environment 100 can include plural data stores, which can be stored locally by the content management system 110, stored somewhere else and accessible using the network 102, generated as needed from various data sources, or some combination of these. Further, some data stores described herein may include identifiers that can be used to match or access corresponding data records or other information that are stored elsewhere, e.g. locally and/or remotely.

A data store of eligible content items 131, for example, can include eligible content items (e.g., advertisements) that can be selected in response to a received request for content. For example, eligible content items may be deemed to be eligible, at least in part, by matching keywords and/or other selection information. The data store of eligible content items 131 can include, for example, an inventory of content items (e.g., creatives) provided by content sponsors 108 for presentation to users. Content items in the data store of eligible content items 131 can have associated with them, for example, per-content item feedback that is stored in a data store of community feedback 132. For example, the data store of community feedback 132 can include feedback provided by users in communities, including user communities that are associated with particular publisher sites. One or more instances of user feedback, provided by one or more different users, can all be associated with a specific content item (e.g., advertisement). Other information can be stored, e.g., that identifies the particular publisher site and/or user community in which the feedback was provided. Further, information stored in the data store of community feedback 132 can be used to annotate content that is provided to users, such as, when a content item is provided, describing or summarizing feedback or recommendations made by other users.

The content management system 110 can include plural engines, some or all of which may be combined or separate, and may be co-located or distributed (e.g., connected over the network 102). A content identification engine 121, for example, can identify candidate content items from the inventory of eligible content items 131 that are responsive to a received request for content. For example, the content identification engine 121 can identify candidate content items from the eligible content items 131, the identification performed, at least in part, by matching keywords or other information in or associated with the request for content. In some implementations, content items selected by the content identification engine 121 can be based on information stored in the data store of community feedback 132. For example, the content identification engine 121 can make selections of content based on statistical analysis of community feedback.

A publisher identification engine 122, for example, can identify a publisher 109 and/or a publisher site associated with a request for content. For example, the publisher site 104a can be identified from among the other websites 104, e.g., based on information included with the request. The publisher identification engine 122 can also look up information associated with a publisher 109, e.g., to determine if a particular publisher 109 authorizes the use of user feedback/recommendations on specific publisher sites associated with the publisher.

An augmentation engine 123, for example, can annotate content items (e.g., advertisements) with feedback and recommendation information, when the information exists for a particular content item. For example, in response to a request received by the content management system 110, the augmentation engine 123 can create a feedback item for insertion into, or inclusion with, a content item, to provide an augmented content item, for example. In some implementations, the feedback item can include a query or some other call-to-action that encourages the user to provide feedback. In some implementations, the feedback item can include information about past feedback provided by other users.

An association engine 124, for example, can associate feedback with a content item for which the feedback was provided, e.g., when the content item was displayed on a publisher site. For example, the association engine 124 can store or update information in the data store of community feedback 132 using information received from users in a community, and the information can be associated with the corresponding content item in the eligible content items 131.

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, gaming consoles, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 can, for example, access the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. Search results pages can also include one or more slots in which other content items (e.g., advertisements) can be presented.

When a resource 105, search results 118 and/or other content (e.g., a video) are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110 in association with a given request. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In addition, when no search is performed or no keywords are available (e.g., because the user is not browsing a webpage), other information, such as information obtained from one or more snapshots, can be used to respond to the received request. In some implementations, the selection of the eligible content items can further depend on user signals, such as demographic signals, behavioral signals or other signals derived from a user profile.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations and a value of learning). The offers represent the amounts that the content sponsors are willing to pay for presentation of (or selection of or other interaction with) their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, a value of learning, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a web site or webpage, registering on a website, experiencing media, or performing a social action regarding a content item (e.g., an ad), such as endorsing, republishing or sharing the content item. Other actions that constitute a conversion can also be used.

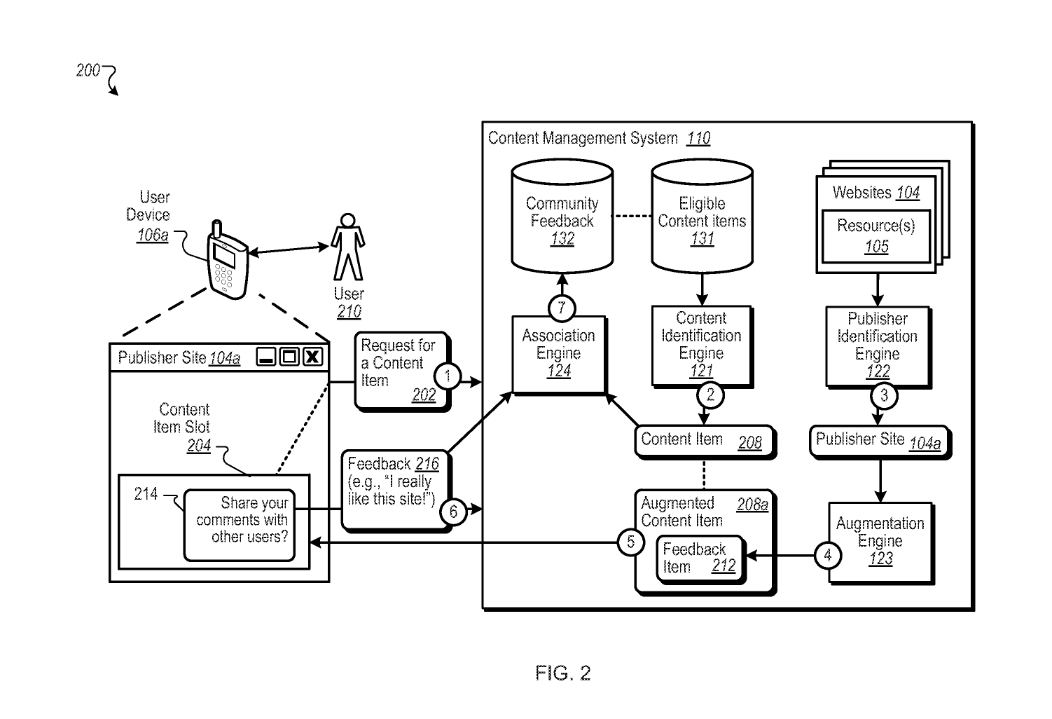

FIG. 2 shows an example system 200 for receiving user community feedback from a user for association with a content item. For example, the content management system 110 can receive a content item request 202 from a user device 106a. The content item request 202, for example, can be a request for a content item 208 (e.g., an advertisement) to fill a content item slot 204 for presentation to a user 210 on a publisher site 104a. A determination can be made, based on information for a publisher 109 associated with the publisher site 104a, when to create an augmented content item 208a that includes a feedback item 212 for obtaining feedback from the user 210. The content management system 110, for example, can provide the augmented content item 208a to the user device 106a for presentation to the user 210. The user 210 can interact with the feedback item 212, e.g., by answering a query 214, resulting in feedback 216 being provided to the content management system 110. At the content management system 110, for example, the feedback 216 can be stored as community feedback 132 and associated with the content item 208, e.g., for use in subsequent presentation of the content item 208, including feedback from one or more users. In some implementations, the following example stages can be used for associating feedback with a content item.

At stage 1, for example, the content management system 110 can receive the content item request 202 from the user device 106a. For example, the content item request 202 can be sent from the user device 106a, such as to fill the content item slot 204 (e.g., an ad slot) on the publisher site 104a being viewed by a user 210. The publisher site 104a, for example, can be one of the websites 104 that is associated with a particular publisher 109.

At stage 2, for example, the content identification engine 121 can identify the content item 208 responsive to the request. For example, the content item 208 identified by the content identification engine 121 can be identified from the eligible content items 131 as a content item that matches selection criteria to fill the content item slot 204. An auction or other selection mechanism can be used to select content item 208 as being responsive to the request.

At stage 3, for example, the publisher identification engine 122 can identify the publisher site 104a based on the request. For example, the publisher site 104a can be identified from among the other websites 104.

At stage 4, for example, the augmentation engine 123 can determine, based on identifying the publisher site 104a, when to augment the content item 208 with a feedback item. When augmentation is indicated, for example, the augmentation engine 123 can augment the content item 208 (e.g., creating augmented content item 208a) to include the feedback item 212 for obtaining feedback from a viewer (e.g., the user 210) of the content item. For example, the feedback item 212 can include a query 214 (e.g., along the lines of “Share your comments with other users?”). The query 214, for example, can query a desire of the user 210 to share the content item 208 with other members of a community (e.g., associated with the publisher site 104a). In some implementations, the query 214 can be part of or in the form of a widget included with the content item that includes a recommendation gatherer. For example, the widget can serve as a recommendation gatherer, e.g., in which users, such as mothers seeing an ad at a new mothers website, are asked specific questions, e.g., “would you like other moms to see this ad?”). Recommendations from the same ad and website can serve, for example, as “signals” from the users, e.g., who are visitors to that web site, and the signals can be gathered and attributed to particular creatives. For example, the query 214 can optionally include a notification, e.g., along the lines of “Other users will see this ad, would you like to comment on it?” or “Do you recommend this ad to other members of this community <name of the website>?” The notification, for example, can be used to notify the user about where the user's comment will appear, how the comment may be used, or otherwise inform the user of the purpose for, or use of, the solicited information.

At stage 5, for example, the content management system 110 can provide the augmented content item 208a responsive to the request. As an example, the augmented content item 208a can be provided to the user device 106a for presentation on the publisher site 104a, e.g., in the content item slot 204.

At stage 6, for example, the content management system 110 can receive feedback 216 from the viewer based on interaction with the feedback item once presented. For example, when the user 210 is presented with the query 214 embedded in the augmented content item 208a, the user 210 can provide the feedback 216. In some implementations, the feedback 216 can serve as one of plural signals from the users (e.g., visitors to the publisher site 104a) that can be gathered and attributed to particular creatives. In some implementations, the query 214 may be hidden, and the query 214 can show up after the user 210 selects or interacts with a feedback control (not shown in FIG. 2). For example, the feedback control can be a small icon (e.g., labeled with an “F” for feedback). In some implementations, the feedback control can appear (e.g., by default) in a location that users learn and understand is for providing feedback.

At stage 7, for example, the association engine 124 can associate the feedback 216 with the content item 208. For example, the association engine 124 can update information in the data store of community feedback 132 to indicate that feedback 216 is to be included when presenting the content item 208, e.g., to other users.

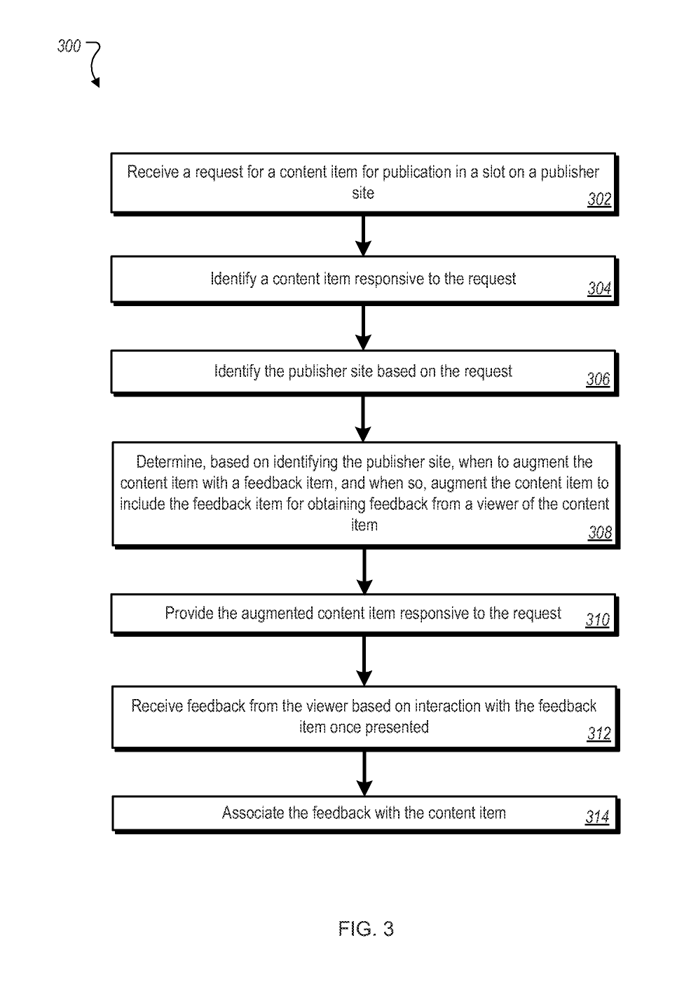

FIG. 3 is a flowchart of an example process 300 for receiving user community feedback from a user for association with a content item for subsequent presentation. In some implementations, the content management system 110 can perform steps of the process 300 using instructions that are executed by one or more processors. FIGS. 1-2 are used to provide example structures for performing the steps of the process 300.

A request is received for a content item for publication in a slot on a publisher site (302). As an example, the content management system 110 can receive the content item request 202 that is sent from the user device 106a, e.g., to fill the content item slot 204 on the publisher site 104a.

A content item responsive to the request is identified (304). As an example, the content identification engine 121 can identify the content item 208 as being responsive to the content item request 202. For example, the content item 208 identified by the content identification engine 121 can be identified from the eligible content items 131 as a content item that matches selection criteria to fill the content item slot 204.

The publisher site is identified based on the request (306). For example, the publisher identification engine 122 can identify the publisher site 104a based on the request. For example, the publisher site 104a can be identified from among the other websites 104. Identification of the publisher site 104a is made in order to obtain information (e.g., as specified by an associated publisher 109) that identifies conditions, if any, under which augmented content items are to be provided.

Based on identifying the publisher site, a determination is made when to augment the content item with a feedback item, and when so, the content item is augmented to include the feedback item for obtaining feedback from a viewer of the content item (308). In some implementations, the feedback item includes a query. In some implementations, the query solicits the viewer to approve sharing the content item with other members of a community associated with the publisher site. For example, the augmentation engine 123 can augment the content item 208 in order to create the augmented content item 208a that includes the feedback item 212. The feedback item 212, for example, can include the query 214 (e.g., along the lines of “Is this a good item for sharing with others that visit this site” or “Can we share your comments with other users?”) or some other format and/or control for obtaining input from the user 210 regarding user feedback. The query 214, for example, can query a desire of the user 210 to share the content item 208 with other members of a community associated with the publisher site 104a, such as other users who frequent the publisher site 104a.

In some implementations, determining when to augment the content item can include determining when one or more of a sponsor associated with the content item or a publisher associated with the publisher site has approved augmentation. For example, some portion of the eligible content items 131 can be defined by an associated content sponsor 108 as being content items for which augmentation is to occur, as described in this document. In some implementations, content sponsors 108 can provide content selection parameters that indicate, for example, that creatives (e.g., advertisement creatives) in a campaign are to include or can be modified to include augmentation in certain conditions, e.g., depending on a type of content item request 202. Conditions can include or relate to, for example, mobile versus non-mobile requests, time of day, user demographics, or other conditions. Similarly, content sponsors 108 may have campaigns for which content items are not to be augmented. Publishers 109 can also control augmentation, for example, based on specific publisher sites 104a that either are approved or not approved for augmentation. Approved publisher sites 104a can have the same or different conditions as described above for content sponsors 108 (e.g., including request types such as mobile versus non-mobile requests, time of day, user demographics, or other conditions) as to when or how augmentation occurs.

The augmented content item is provided responsive to the request (310). The content management system 110, for example, can provide the augmented content item 208a responsive to the content item request 202. As an example, the content management system 110 can provide the augmented content item 208a to the user device 106a for presentation on the publisher site 104a, e.g., in the content item slot 204.

In some implementations, augmenting the content item can include associating the feedback item with the content item and delivering the content item and the feedback item responsive to the request. For example, the augmentation engine 123 can associate the feedback item 212 with the content item 208, and the content management system 110 can provide the feedback item 212 and the content item 208 in response to the content item request 202.

In some implementations, augmenting the content item can include appending to or overlaying the feedback item on the content item, creating a single unit, and providing the single unit responsive to the request. For example, the augmentation engine 123 can embed or otherwise overlay the feedback items 212 in the augmented content item 208a, as described above. When the content item 208 is an advertisement, for example, the embedding or overlaying can occur in a portion of the content item 208 that is free space, free of text, or that does not obscure important parts (e.g., image features) in the content item.

Feedback is received from the viewer based on interaction with the feedback item once presented (312). The content management system 110, for example, can receive feedback 216 from the viewer based on interaction with the feedback item once presented. For example, when the user 210 is presented with the query 214 embedded in the augmented content item 208a, the user 210 can provide the feedback 216 (e.g., an answer to the query).

The feedback is associated with the content item (314). For example, the association engine 124 can associate the feedback 216 with the content item 208. For example, the association engine 124 can update information in the data store of community feedback 132 to indicate that feedback 216 is to be included when presenting the content item 208, e.g., to other users.

In some implementations, associating the feedback with the content item can include storing the feedback, and the process 300 can further include receiving a second request for content for publication in a slot on the publisher page, identifying one or more candidate content items responsive to the request, identifying feedback for the candidate content items based on the storing, and using the feedback to select a content item responsive to the second request. For example, sometime after the content management system 110 receives and processes the content item request 202, as described above, an additional content item request 202 can be received. The request, for example, can be a request for a content item to fill the same content item slot 204, or the request can be to fill a different slot on the publisher site 104a. In response to the received second content item request 202, for example, the content identification engine 121 can identify one or more of the eligible content items 131 that are responsive to the request. The content identification engine 121 can select a particular one of the eligible content items 131 to provide in response to the request based on stored feedback that is associated with the content item.

In some implementations, the process 300 can further include accumulating feedback for the content item from plural different viewers that visit the publisher site, determining statistical relevance of the feedback, and when relevant, using the feedback when deciding content items for delivery to other viewers that visit the publisher site in the future. For example, the content management system 110 can process multiple instances of feedback 216 that have been provided by plural users 210. The content identification engine 121, for example, can evaluate plural instances of stored feedback 216. The evaluation can include, for example, identifying instances of each of positive, neutral and negative feedback. The content management system 110, for example, can perform statistical analysis on the feedback and determine, for example, when to provide the content item 208 to other users who visit the publisher site 104a. For example, if a website, such as the publisher site 104a, caters to a geographically and demographically large audience, sufficient statistics may exist to match “recommended ads” to ad requests, e.g., to use user signals in the form of feedback 216 to determine which ad(s) to show. Content items (e.g., advertisements) can be selected, for example, based on relevance (e.g., based on matching one or more criteria) and/or significance (e.g., determined based on performance metrics such as click-through rates or other user interactions).

In some implementations, the process 300 can further include providing a recommendation along with a content item that is delivered based on the accumulated feedback. For example, the content management system 110 can include, such as using an overlay, a feedback-derived recommendation, e.g., along the lines of “Several people have recommended this product!”

In some implementations, the recommendation can include an indication of a number of prior viewers of the community that recommended the content item. For example, the content management system 110 can include, with the recommendation, information along the lines of “14 people visiting the Example Site liked the ad and recommended the shoes.” Other formats and information can be provided, e.g., including using a rating (e.g., determined for each content item). For example, notification can include information along the lines of “X % of Example Site moms watched and approved/recommended this ad” or “Some number N of Example Site moms . . . Click here to expand.” Other formats and information are possible.

In some implementations, the process 300 can further include determining, for a given candidate content item, a statistical relevance of the feedback, and when relevant, using the feedback as a signal in a selection algorithm for determining the content item from the candidate content items. For example, the content management system 110 can analyze the received feedback 216 and determine, using statistical techniques, when to include, such as using an overlay, a feedback-derived recommendation, such as along the lines of “14 people visiting the Example Site liked the ad about shoes.”

In some implementations, the statistical relevance can be based on interaction rates with content items that are selected when feedback is used to select a given content item. For example, the content management system 110 can track user interactions (e.g., click-throughs, conversions, etc.) that occur when users are presented content items that are selected based on existing stored feedback 216. Eligible content items 131 that have a higher click-through rate (or that have a higher conversion rate) can be selected by the content identification engine 121 over eligible content items having lower interaction rates.

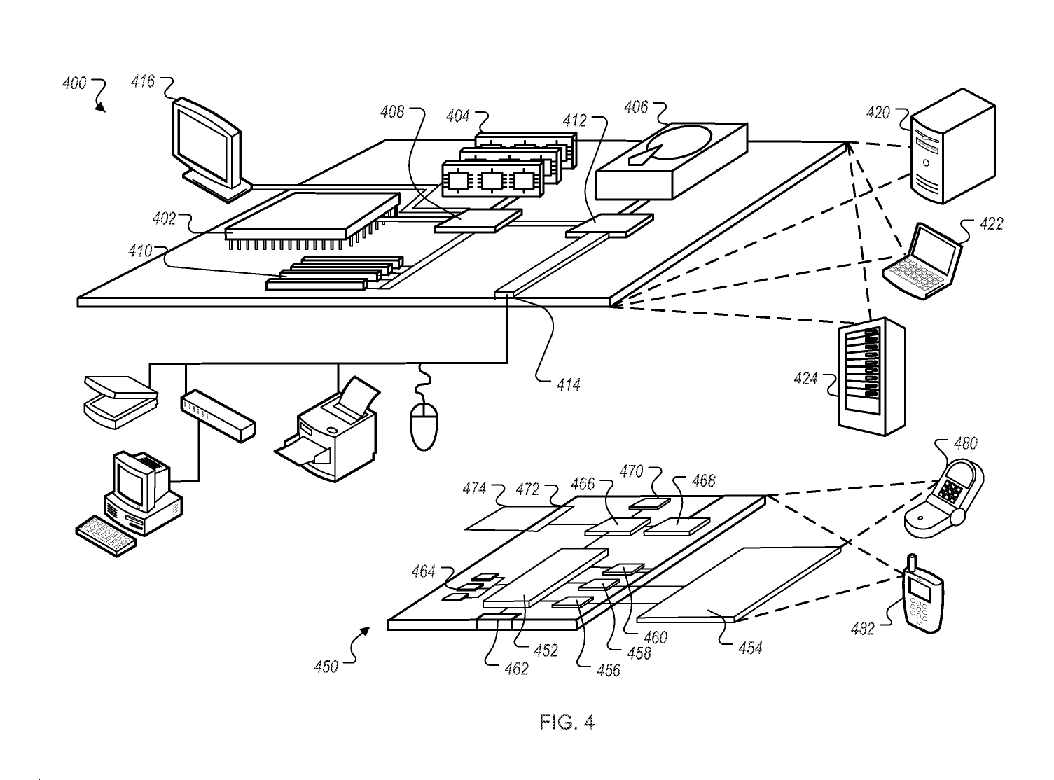

FIG. 4 is a block diagram of example computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processers embedded therein or attached thereto. Computing device 450 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 400 includes a processor 402, memory 404, a storage device 406, a high-speed controller 408 connecting to memory 404 and high-speed expansion ports 410, and a low-speed controller 412 connecting to low-speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high-speed controller 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low-speed controller 412 manages lower bandwidth-intensive operations. Such allocation of duties is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed bus 414. The low-speed bus 414 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as computing device 450. Each of such devices may contain one or more of computing devices 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The computing device 450 may also be provided with a storage device, such as a micro-drive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the computing device 450, such as control of user interfaces, applications run by computing device 450, and wireless communication by computing device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of computing device 450 with other devices. External interface 462 may provide, for example, for wired communication (e.g., via a docking procedure) or for wireless communication (e.g., via Bluetooth® or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to computing device 450 through expansion interface 472, which may include, for example, a subscriber identification module (SIM) card interface. Such expansion memory 474 may provide extra storage space for computing device 450, or may also store applications or other information for computing device 450. Specifically, expansion memory 474 may include instructions to carry out or supplement the processes described above, and may include secure information also. Thus, for example, expansion memory 474 may be provide as a security module for computing device 450, and may be programmed with instructions that permit secure use of computing device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Computing device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 468 (e.g., a radio-frequency transceiver). In addition, short-range communication may occur, such as using a Bluetooth®, WiFi, or other such transceiver (not shown). In addition, GPS receiver module 470 may provide additional wireless data to computing device 450, which may be used as appropriate by applications running on computing device 450.

Computing device 450 may also communicate audibly using audio codec 460, which may receive spoken information from a user and convert it to usable digital information. Audio codec 460 may likewise generate audible sound for a user, such as through a speaker, e.g., in a handset of computing device 450. Such sound may include sound from voice telephone calls, may include recorded sound (e.g., voice messages, music files, etc.) and may also include sound generated by applications operating on computing device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a request for a content item for publication in a slot on a given publisher site provided by a publisher;
identifying, using one or more processors, a content item of a content sponsor responsive to the request, with the publisher being distinct from the content sponsor;
identifying the given publisher site based on the request;
identifying multiple publisher sites provided by publishers, wherein at least one of the publisher sites is not approved for augmentation of content and wherein at least one other of the publisher sites is approved for augmentation of content;
determining, from among the publisher sites, that the identified given publisher site is included in the at least one other of the publisher sites approved for augmentation of content;
identifying a feedback control that shares the content item from a member of an online community hosted by the given publisher site with other members of the online community in response to user interaction with the feedback control;
augmenting the content item for publication in the slot on the given publisher site based on the given publisher site being included in the at least one other of the publisher sites approved for augmentation of content to include, when rendered on a display device, the identified feedback control as part of the content item;
providing, to the given publisher site that hosts the online community, the augmented content item responsive to the request;
receiving feedback from the member based on interaction with the identified feedback control once presented, with the feedback only being sharable with the other members of the online community hosted by the given publisher site;
associating the feedback with the augmented content item; and
providing the augmented content item and the associated feedback to one or more of the other members of the online community hosted by the given publisher site.

2-3. (canceled)

4. The computer-implemented method of claim 1 wherein augmenting includes appending the feedback control to or overlaying the feedback control on the content item, creating a single unit, and providing the single unit responsive to the request.

5. The computer-implemented method of claim 1 further comprising accumulating feedback for the content item from plural different viewers that visit the given publisher site, determining statistical relevance of the accumulated feedback, and when relevant, using the statistical relevance of the accumulated feedback when deciding content items for delivery to other viewers that visit the given publisher site in the future.

6. The computer-implemented method of claim 5 further comprising providing a recommendation along with a content item that is delivered based on the accumulated feedback.

7. The computer-implemented method of claim 6 wherein the recommendation includes an indication of a number of prior viewers of the online community that recommended the content item that is delivered based on the accumulated feedback.

8. The computer-implemented method of claim 1 wherein associating the feedback with the content item includes storing the feedback, and wherein the method further comprises receiving a second request for content for publication in a slot on the given publisher site, identifying one or more candidate content items responsive to the second request, identifying accumulated feedback for the candidate content items based on the storing, and using the accumulated feedback to select a content item responsive to the second request.

9. The computer-implemented method of claim 8 further comprising determining, for a given candidate content item, a statistical relevance of the accumulated feedback, and when relevant, using the statistical relevance of the accumulated feedback as a signal in a selection algorithm for determining the given candidate content item from the candidate content items.

10. The computer-implemented method of claim 9 wherein statistical relevance is based on interaction rates with content items that are selected when feedback is used to select the given candidate content item.

11. A non-transitory computer-readable medium storing instructions, that when executed, cause one or more processors to perform operations including:
receiving a request for a content item for publication in a slot on a given publisher site provided by a publisher;
identifying a content item of a content sponsor responsive to the request, with the publisher being distinct from the content sponsor;
identifying the given publisher site based on the request;
identifying multiple publisher sites provided by publishers, wherein at least one of the publisher sites is not approved for augmentation of content and wherein at least one other of the publisher sites is approved for augmentation of content;
determining, from among the publisher sites, that the identified given publisher site is included in the at least one other of the publisher sites approved for augmentation of content;
identifying a feedback control that shares the content item from a member of an online community hosted by the given publisher site with other members of the online community in response to user interaction with the feedback control;
augmenting the content item for publication in the slot on the given publisher site based on the given publisher site being included in the at least one other of the publisher sites approved for augmentation of content to include, when rendered on a display device, the identified feedback control as part of the content item;
providing, to the given publisher site that hosts the online community, the augmented content item responsive to the request;
receiving feedback from the member based on interaction with the identified feedback control once presented, with the feedback only being sharable with the other members of the online community hosted by the given publisher site;
associating the feedback with the augmented content item; and
providing the augmented content item and the associated feedback to one or more of the other members of the online community hosted by the given publisher site.

12-13. (canceled)

14. The non-transitory computer-readable medium of claim 11 wherein augmenting includes appending the feedback control to or overlaying the feedback control on the content item, creating a single unit, and providing the single unit responsive to the request.

15. The non-transitory computer-readable medium of claim 11 further including instructions, that when executed, cause one or more processors to: accumulate feedback for the content item from plural different viewers that visit the given publisher site, determine statistical relevance of the accumulated feedback, and when relevant, use the statistical relevance of the accumulated feedback when deciding content items for delivery to other viewers that visit the given publisher site in the future.

16. A system comprising:
one or more processors; and
one or more memory elements including instructions that, when executed, cause the one or more processors to:
receive a request for a content item for publication in a slot on a given publisher site provided by a publisher;
identify a content item of a content sponsor responsive to the request, with the publisher being distinct from the content sponsor;
identify the given publisher site based on the request;
identify multiple publisher sites provided by publishers, wherein at least one of the publisher sites is not approved for augmentation of content and wherein at least one other of the publisher sites is approved for augmentation of content;
determine, from among the publisher sites, that the identified given publisher site is included in the at least one other of the publisher sites approved for augmentation of content;
identify a feedback control that shares the content item from a member of an online community hosted by the given publisher site with other members of the online community in response to user interaction with the feedback control;
augmenting the content item for publication in the slot on the given publisher site based on the given publisher site being included in the at least one other of the publisher sites approved for augmentation of content to include, when rendered on a display device, the identified feedback control as part of the content item;
provide, to the given publisher site that hosts the online community, the augmented content item responsive to the request;
receive feedback from the member based on interaction with the identified feedback control once presented, with the feedback only being sharable with the other members of the online community hosted by the given publisher site;
associate the feedback with the augmented content item; and
provide the augmented content item and the associated feedback to one or more of the other members of the online community hosted by the given publisher site.

17-18. (canceled)

19. The system of claim 16 wherein augmenting includes appending the feedback control to or overlaying the feedback control on the content item, creating a single unit, and providing the single unit responsive to the request.

20. The system of claim 16 further including instructions, that when executed, cause one or more processors to: accumulate feedback for the content item from plural different viewers that visit the given publisher site, determine statistical relevance of the accumulated feedback, and when relevant, use the statistical relevance of the accumulated feedback when deciding content items for delivery to other viewers that visit the given publisher site in the future.
